(19) United States
(12) Patent Application Publication
(10) Pub. No.: US 2013/0195558 A1
(43) Pub. Date: Aug. 1, 2013

(54) METHOD AND DEVICE FOR STABILIZING A CONDUCTOR IN A SUBMERGED CONDUCTOR GUIDE

(71) Applicant: Kjell Bjørnar Størksen, Os (NO)

(72) Inventor: Kjell Bjørnar Størksen, Os (NO)

(73) Assignee: OCEANEERING ASSET INTEGRITY AS

(21) Appl. No.: 13/816,019

(22) PCT Filed: Aug. 5, 2011
(86) PCT No.: PCT/NO2011/000220

§ 371 Date: Apr. 12, 2013

Related U.S. Application Data
(60) Provisional application No. 61/344,504, filed on Aug. 10, 2010.

(51) Int. Cl. H02G 9/06

(52) U.S. Cl. CPC H02G 9/06
USPC 405/184.4

(57) ABSTRACT

A method and device for stabilizing a conductor (4) in a submerged conductor guide (6) on an offshore installation (8) where an annulus (2) is present between the conductor (4) and the conductor guide (6), wherein the method includes:—establishing any misalignment between the conductor (4) and the conductor guide (6);—producing a support body (1) that is adapted to said misalignment and where the support body (1) is designed to fill a sector of the annulus (2); and—moving the support body (1) axially into the annulus (2) between the conductor (4) and the conductor guide (6).

There is provided a method for stabilizing a conductor in a submerged conductor guide. More precisely there is provided a method for stabilizing a conductor in a submerged conductor guide on an offshore installation where an annulus is present between the conductor and the conductor guide. The invention also includes a device for stabilizing a conductor in a submerged conductor guide.

In offshore installations, in particular installations used for petroleum exploitation, it is common to stabilize conductors by passing them through one or more conductor guides. A conductor guide typically has the form of a pipe-formed ring that is welded to the installation structure.

The inner diameter of the conductor guide is normally substantially larger than the outer diameter of the conductor. An annulus is thus formed between the conductor guide and the conductor.

Traditionally a steel frame is placed in the annulus for stabilizing the conductor in the conductor guide. The steel frame may be designed to take up any misalignment between the conductor and conductor guide.

Experience shows that such steel frame systems are sensitive to wave-induced forces and that such forces may induce fracturing, fatigue or stability problems to the conductor guide.

The purpose of the invention is to overcome or reduce at least one of the draw-backs of prior art, or at least provide a useful alternative to prior art.

The purpose is achieved according to the invention by the features as disclosed in the description below and in the following patent claims.

There is provided a method for stabilizing a conductor in a submerged conductor guide on an offshore installation where a annulus is present between the conductor and the conductor guide, wherein the method includes:
establishing any misalignment between the conductor and conductor guide;
producing a support body that is adapted to said misalignment where the support body is designed to fill a sector of the annulus; and
moving the support body axially into the annulus between the conductor and the conductor guide.

The support body may typically be produced as a casting in an elastic material. A polymer material sold under the trademark “Elastogran” by BSAF has proved suitable. By producing the support bodies in a suitable form for filling a sector of the annulus, the support body may relatively easily be positioned at the conductor guide and then moved into the annulus.

The method may further include positioning of the support body at the conductor guide and moving the support body into the annulus by use of a remote operated vehicle (ROV).

By utilizing an ROV for moving and inserting the support body into the annulus, a diver less installation is achieved.

The method may further include locking the support body in the conductor guide. In this way the support body is prevented from moving out of the conductor guide.

The method may further include, while installing the support body, having a buoyancy aid connected to the support body.

The buoyancy aid may compensate for the weight of the support body and a locking mechanism during transport and installation of the support body in the water.

There is also provided a support body for positioning in an annulus between a conductor and a conductor guide in an off-shore installation, wherein the support body is equipped with a lock that is movable between a passive position and an active position, and where the lock engages with the conductor guide.

The lock may include a hinged lock member. Under some circumstances a slidable lock member would be preferable. It could be advantageous to position the centre of gravity of the lock member in such a way that the lock member by gravity will move from its passive position and to its active, locking position.

The lock member may be connected to a frame that is embedded in the support body. The frame may be cast in an elastic material of the support body.

The hinged lock member may in its passive position be placed in an aperture of the support body.

Although the terms “conductor” and “conductor guide” are used throughout this document, these terms does not limit the scope of the invention as a person skilled in the art will understand that the invention may apply to any kind of tubular or shaft.

The method and device according to the invention make it possible to install support bodies by use of ROV's, thus avoiding the use of divers with the involved hazards and cost. Further, the properties of the design and materials used render the system tolerable to wave-induced forces.

Below, an example of a preferred method and device is explained under reference to the enclosed drawings, where:

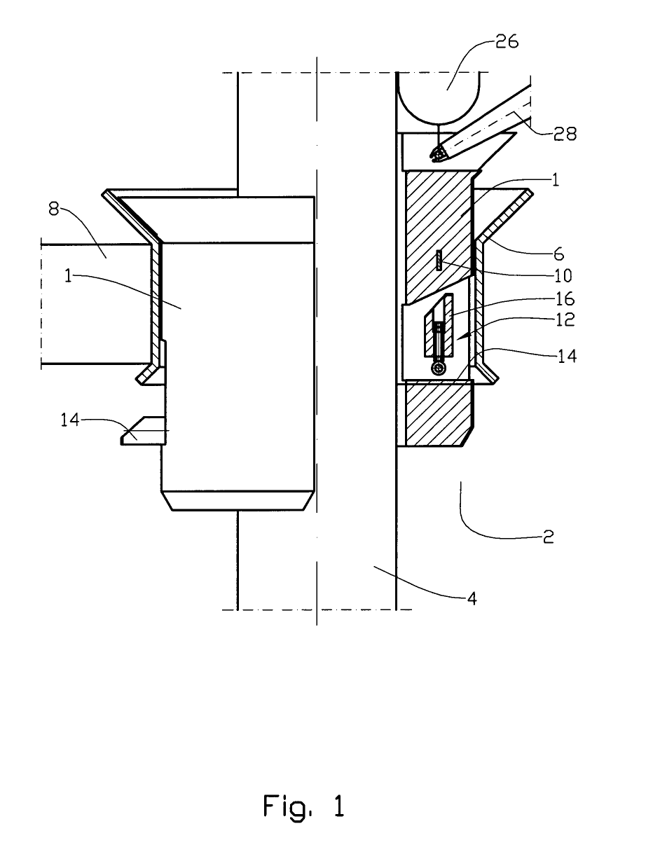

FIG. 1 shows vertical section of a conductor guide and a support body according to the invention;

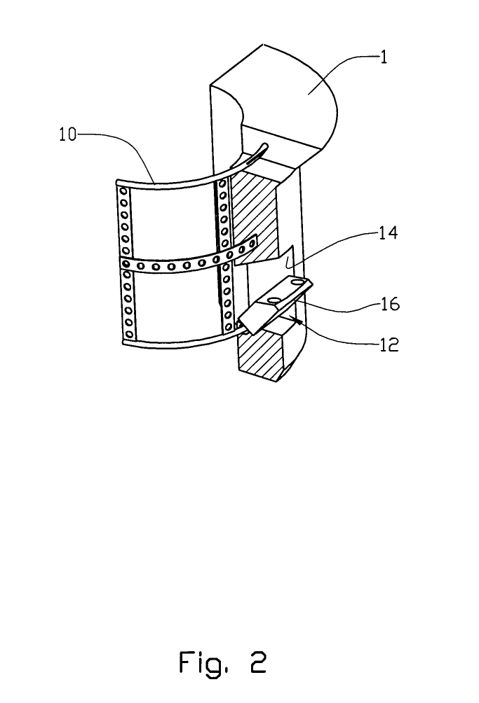

FIG. 2 shows a perspective view of a support body of FIG. 1 where some of the support body material is removed; and

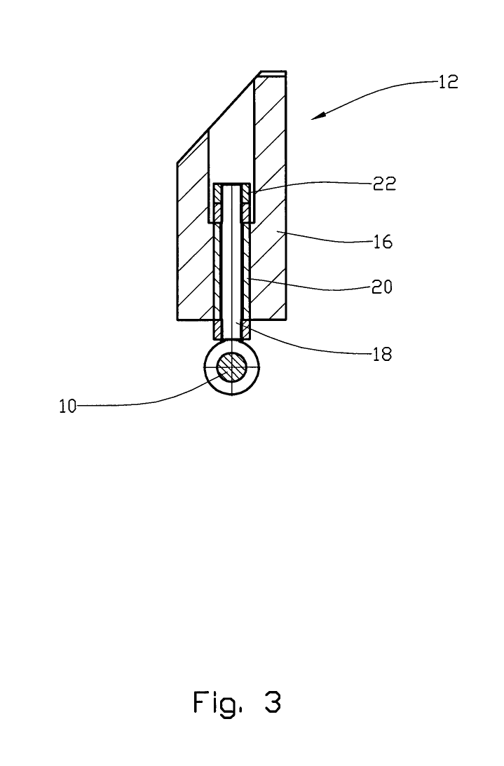

FIG. 3 shows to a larger scale a lock in FIG. 1.

On the drawings the reference number 1 denotes a support body suitable for positioning in an annulus 2 between a conductor 4 and a conductor guide 6. In this embodiment the support body 1 is designed to fill a little less than 180 degrees of the annulus sector. The sector filled by one support body may in some cases be different from this. More than two support bodies 1 may be needed in order to fill the annulus 2. The conductor guide 6 is welded to an offshore installation 8.

In this preferred embodiment the support body 1 is cast in an elastic material and adapted to any misalignment of the conductor 4 in the conductor guide 6.

As shown in FIG. 2, a frame 10 is cast into the support body 1. The frame 10 is designed to give good attachment to the support body 1. The purpose of the frame 10 is to carry a lock 12 that is positioned in an aperture 14 of the support body 1.

The lock 12 includes a lock member 16 that by use of two hinge bolts 18 is hinged to the frame 10, see FIG. 3.

Each hinge bolt 18 is passed through a sleeve 20 that is casted in the lock member 16. The hinge bolts 18 are fixed to the lock members 16 by nuts 22.

As shown in FIG. 1 right side of the drawing, the lock 12 is in its passive position, while on the left side of the drawing the lock 12 is in an active position engaged with the conductor guide 6. In FIG. 2 the lock 12 is shown in a position between the two positions shown in FIG. 1.

When a conductor 4 is to be stabilized in a conductor guide 6, any misalignment is determined and a support body 1 produced with a frame 10 and lock 12 incorporated. The dimensions of the support body 1 are adapted to any misalignment.

A buoyancy aid 26 of predetermined size is attached to the support body 1 and the support body 1 and the buoyancy aid 26 connected to an ROV 28. The ROV 28 is transporting the support body 1 to the conductor guide 6 in question. The support body 1 is moved into the annulus 2 between the conductor 4 and the conductor guide 6.

When the support body 1 is in position the lock 12 is moved from its passive position to its active position, thus preventing the support body 1 from moving out of the annulus 2.

The buoyancy aid 26 and the ROV 28 are disconnected from the support body 1.

The procedure is repeated with at least one other support body 1 in order to substantially fill the annulus 2 with support bodies 1.

1. A method for stabilizing a conductor in a submerged conductor guide on an offshore installation where an annulus is present between the conductor and the conductor guide, the method comprising:
establishing any misalignment between the conductor and the conductor guide;
producing a support body that is adapted to said misalignment and where the support body is designed to fill a sector of the annulus; and
moving the support body axially into the annulus between the conductor and the conductor guide.

2. A method according to claim 1, further comprising positioning the support body at the conductor guide and moving the support body into the annulus by use of a remote operated vehicle.

3. A method according to claim 1, further comprising locking the support body in the conductor guide.

4. A method according to claim 1, further comprising having a buoyancy aid connected to the support body while installing the support body.

5. A support body for positioning in an annulus between a conductor and a conductor guide in an offshore installation, the support body comprising a lock that is movable between a passive position and an active position where the lock engages with the conductor guide.

6. A support body according to claim 5, wherein the lock comprises a hinged lock member.

7. A support body according to claim 6, wherein the hinged lock member is connected to a frame that is at least partly embedded in the support body.

8. A support body according to claim 7, wherein the frame is cast in an elastic material of the support body.

9. A support body according to claim 6, wherein the hinged lock member in a passive position is placed in an aperture of the support body.

10. A system comprising:
the support body according to claim 5;
the conductor; and
the conductor guide.

11. A system according to claim 10, wherein the lock comprises a hinged lock member.

12. A system according to claim 11, wherein the hinged lock member in a passive position is placed in an aperture of the support body.

13. A system according to claim 11, wherein the hinged lock member is connected to a frame that is at least partly embedded in the support body.

14. A system according to claim 13, wherein the frame is cast in an elastic material of the support body.
